(19) United States
(12) Patent Application Publication
(10) Pub. No.: US 2016/0290477 A1
(43) Pub. Date: Oct. 6, 2016

(54) LINEAR ELECTRO-MECHANICAL ACTUATOR

(71) Applicant: AKTIEBOLAGET SKF, Göteborg (SE)

(72) Inventors: Par Hogberg, Göteborg (SE); Mikael Brage, Mölnlycke (SE)

(73) Assignee: Aktiebolaget SKF, Goteborg (SE)

(21) Appl. No.: 15/038,624

(22) PCT Filed: Nov. 14, 2014
(86) PCT No.: PCT/SE2014/051353

§ 371 Date: May 23, 2016

(30) Foreign Application Priority Data
Nov. 25, 2013 (SE) 1300732-3

(51) Int. Cl. F16H 57/04; F16H 25/24; F16H 25/20; H02K 7/06

(52) U.S. Cl. CPC F16H 57/0406; H02K 7/06; F16H 25/2454; F16H 25/20; F16H 57/0497

(57) ABSTRACT

The present invention relates to a linear electro-mechanical actuator for transferring a rotational motion to a linear motion. The actuator includes a piston having an outer surface and being at least partly arranged inside a housing. The housing includes an inner load-carrying surface. The actuator provides a transmission module adapted to transfer a rotational motion generated by a motor to a linear motion of the piston. The actuator further provides a load-carrying member and a lubricating member having a porous polymeric matrix and a lubricating material, the load-carrying member and the lubricating member being arranged adjacent to each other. The present actuator allows for lubrication of at least a portion of the inner load-carrying surface of the housing by the lubricating material upon movement of the piston. For instance, the linear electro-mechanical actuator may not require, or may at least minimize, the need of relubrication.

### TECHNICAL FIELD OF INVENTION

The present invention relates to a linear electro-mechanical actuator for transferring a rotational motion to a linear motion. The linear electro-mechanical actuator comprises a piston, a housing, a transmission module, a load-carrying member and a lubricating member.

### BACKGROUND

Linear actuators are used to move an object along a straight line, either between two end points or to a defined position. Linear electro-mechanical actuators typically incorporate a rotating electrical motor and some kind of mechanical transmission module to convert the relatively high-speed rotation of the motor to a low speed linear motion. This transmission module may incorporate a gear box and/or a screw shaft.

Linear electro-mechanical actuators are constructed to perform many thousands to hundreds of thousands, or more, strokes (i.e. movements of the object along the straight line) over relatively long travel distances. Upon use, surfaces of the linear actuators are thus subjected to stressing loads, such as rotational, radial and/or axial forces, which may throw off and/or scrape off lubricants being applied to these surfaces. Consequently, these surfaces require continuous relubrication in order to ensure a long service life of the linear actuators.

Today, relubrication is a troublesome operation and often large amounts of lubricants are wasted due to unprecise application with regard to both the location in the actuator and the amount of lubricants applied. Hence, there is a need in the art for more efficient lubrication of linear electro-mechanical actuators.

### SUMMARY OF THE INVENTION

In a linear electro-mechanical actuator, a piston, extending in an axial direction, is typically at least partly arranged inside a housing and moveable relative to the housing in the axial direction.

The piston is adapted to work in the axial direction, typically, over long travelling distances. In order to keep a high efficiency of the actuator, radial forces, such as buckling, and/or torotional forces acting on the piston upon use of the actuator must be handled. Typically, a load-carrying member is arranged in between the piston and the housing in a radial direction in order to increase the stability of the actuator. However, the service life and performance of the load-carrying member is highly dependent on proper lubrication of its load-carrying surface(s) as well as of the inner surface of the housing, wherein the latter at least partly faces the load-carrying member.

As stated above, actuators known in the state of the art can typically not satisfy the requirements regarding, for instance, a defined location of lubricants and a defined amount of lubricants. Typically, the actuators known in the state of the art are in need of regular relubrication due to e.g. migration of lubricants and excessive consumption of lubricants.

The present invention serves to overcome at least some of the problems known in the prior art by providing a linear electro-mechanical actuator which is capable of improving the application of the lubrication in terms of precision and functionality, while providing a useful amount of a lubricating material. The linear electro-mechanical actuator according to the present invention may not require or at least minimize the need of relubrication.

According to an aspect of the present invention, a linear electro-mechanical actuator for transferring a rotational motion to a linear motion is provided. The linear electro-mechanical actuator comprises a piston having a distal end and a proximal end. The piston extends in an axial direction and has an outer surface. The piston is at least partly arranged inside a housing and moveable relative to the housing in the axial direction. The housing defines an inner milieu and has an inner load-carrying surface. The linear electro-mechanical actuator further comprises a transmission module operatively connected to the proximal end of the piston and adapted to transfer a rotational motion generated by a motor to a linear motion of the piston in the axial direction. The linear electro-mechanical actuator further comprises a load-carrying member being arranged in between the piston and the housing as seen in a radial direction at the proximal end of the piston. The linear electro-mechanical actuator further comprises a lubricating member comprising a porous polymeric matrix and a lubricating material. The lubricating member is present in the inner milieu and arranged in between the housing and the piston as seen in the radial direction at the proximal end of the piston. The lubricating member is arranged adjacent to the load-carrying member. Thereby, the actuator allows for lubrication of at least a portion of the inner load-carrying surface of the housing by the lubricating material upon movement of the piston. Advantageously, the arrangement also allows for lubrication of a portion of the load-carrying member, such as the surface facing the housing, via the lubrication of the inner surface of the housing.

Advantages of the linear electro-mechanical actuator according to the present invention, will be described in more detail throughout the application text, and are also summarized below:
The linear electro-mechanical actuator may be easily assembled in a dry state of the lubricating member, i.e. with no smeary grease, or other form of liquid or semi-liquid lubricating material, present except in the porous polymeric matrix of the lubricating member.
The linear electro-mechanical actuator may allow for a precise arrangement of the lubricating member, having a predetermined size and shape, at a location in the actuator where it is needed the most, i.e. adjacent to load-carrying surfaces subjected to harsh loads upon use of the actuator.
The linear electro-mechanical actuator may allow for less maintenance than required for a conventional actuator due to no need of relubrication during its service life as well as due to less wear of the components of the actuator.
The linear electro-mechanical actuator may easily be used due to a relatively controlled consumption of lubricating material causing substantially no leakage of lubricating material as well as due to its tolerance to e.g. washing.
The linear electro-mechanical actuator may have an improved dwell and stock time due to a high stability of the lubricating member leading to less problems with e.g. oil separation.
The linear electro-mechanical actuator may have a predictable service life due to a known amount of lubricating material in the lubricating member as well as due to a known location of the lubricating member in the actuator.
The linear electro-mechanical actuator may allow for environmentally friendly handling of the lubricating member including the unconsumed lubricating material at end of service life, in particular when provided as a separate member.

In an embodiment, the actuator allows for lubrication of substantially the entire inner load-carrying surface of the housing by the lubricating material. By the term “substantially” is herein meant at least 90% of the inner load-carrying surface of the housing, such as at least 95% of the inner load-carrying surface of the housing.

By the term “piston” is herein meant the moveable, typically stroking, component of the actuator performing a linear motion in the axial direction. The piston may extend from the inner milieu into the outer milieu and may retract from the outer milieu into the inner milieu upon use of the actuator. In a fully retracted state, the piston is mainly, typically entirely, arranged in the inner milieu. In a fully extended state, the piston is mainly, typically entirely, arranged in the outer milieu. The piston may sometimes be referred to as an extension member, e.g. an extension tube, of the linear electro-mechanical actuator. The piston typically has, but is not limited to, the general shape of a circular cylinder. The piston may be solid or hollow. Typically, the piston is at least partially hollow. The piston may be metallic. For instance, the piston may be made of steel, e.g. stainless steel.

The “axial direction” refers to the direction of the central axis of the piston. The “radial direction” refers to the direction of the radius of the piston.

By the term “lubricating member” is herein meant a member comprising a porous polymeric matrix and a lubricating material. The lubricating member is a component of the actuator serving to lubricate a load-carrying surface or load-carrying surfaces of the actuator. Such a load-carrying surface may be the inner surface of the housing, a portion of a guiding member facing the piston, and/or a portion of a rotational locking. The lubricating member is arranged adjacent to the load-carrying member. The lubricating member may be arranged between the piston and the housing as seen in a radial direction. Typically, the lubricating member is arranged close to the proximal end of the piston, at least when the piston is in a fully retracted state. Alternatively, or additionally, the lubricating member may be arranged in the rotational locking, such as in between the a male spline of the rotational locking forming a portion of the load-carrying member and the piston.

The lubricating member is generally attached to the piston. The lubricating member may be directly or indirectly attached to the piston. For example, the lubricating member is directly or indirectly attached to the outer surface of the piston. Thus, the lubricating member is generally not freely moveable in the axial direction relative to the piston. On the other hand, both the lubricating member and the piston are generally freely moveable in the axial direction relative to the housing.

A load-carrying surface, e.g. the inner surface of the housing moving, such as sliding, against the lubricating member may be provided with an even and consistent film of the lubricating material. A moderate increase in temperature, which may occur upon use of the actuator, may cause the lubricating material to be pushed towards the surface of the polymeric matrix, as the thermal expansion of the lubricating material typically is greater than that of the polymeric matrix. The viscosity of the lubricating material typically decreases with increasing temperature. When the actuator stops working, the polymeric matrix may reabsorb excess lubricating material.

Typically, the porous polymeric matrix is saturated with the lubricating material. The lubricating member may comprise about 50-80%, such as 65-75%, e.g. 70%, by weight of the lubricating material. The lubricating material may for instance be a lubricating oil, such as a high quality oil, a very high quality synthetic oil, or other fluid lubricant of ample viscosity.

The polymeric matrix has a porous structure. Typically, the porous structure comprises millions of pores, e.g. micro-pores. Each pore has a size such small that they may hold the lubricating material by surface tension. The porous polymeric matrix may be a polymer matrix, such as a micro-porous polymer matrix, e.g. a polyethylene matrix. Typically, the porous polymeric matrix is molded.

Due to the porosity of the polymeric matrix, the lubricating member has a relatively low strength and substantially no bearing capacity. Generally, the lubricating member is not load-carrying, since too much friction and/or heat would obstruct the pores of the lubricating member.

The lubricating member has predictable properties, such as a pre-determined volume and a known content of lubricating material, and thereby also a predictable service life. The predictable nature of the lubricating member prevents and avoids the actuator from relubrication. The size, i.e. the volume, may be adapted to correspond to the lubrication needs of the actuator. The level of saturation of lubricating material within the lubricating member may be adapted to correspond to the lubrication needs of the actuator.

The lubricating member has an advantage in that it remains firm in shape over its service life. A lubricating member according to the present invention is easy to apply to the linear electro-mechanical actuator, e.g. due to its non-smeary nature. Sometimes, the lubricating member is referred to as a solid oil.

The lubricating member may allow for a service life of the actuator device being increased with at least one order of magnitude expressed in strokes before breakage compared to conventional actuator devices using conventional lubricants, such as oil, grease etc.

The lubricating member may allow for an improved stocking and dwell time. The lubricating member keeps lubricating material, typically a lubricating oil, bonded better than e.g. soap in grease, and hence lessens the problem with oil separation over time.

The lubricating member has a good initial lubrication and allows for dry assembly. The lubricating member is relatively insensitive to dirt, cleaning and changes in temperature. For instance, the lubricating member may withstand temperatures within the range of from −40° C. to +85° C.

In the present invention, the lubricating member is arranged in close proximity to the surface(s) of the linear electro-mechanical actuator being subjected to harsh loads upon use of the actuator. The lubricating material of the lubricating member gradually migrates to the load-carrying surface(s).

Typically, the lubricating member is arranged such it allows for lubrication of a least a portion, either in the axial direction or the radial direction, of the load-carrying surface(s) by the lubricating material. For instance, the lubricating member may lubricate the entire periphery of a cross-section of the load-carrying surface(s). Advantageously, the lubricating member is arranged such it allows for lubrication of the entire load-carrying surface(s) by the lubricating material. For instance, the lubricating member lubricates the entire inner load-carrying surface of the housing, and may thus lubricate the inner load-carrying surface of the housing over the long travel distance of the lubricating member relative to the housing.

The lubricating member may be arranged in close proximity to the load-carrying member. Hence, the lubricating member may be arranged at a minor distance from the load-carrying member. The load-carrying member is arranged in between the piston and the housing as seen in a radial direction at the proximal end of the piston, thereby being subjected to a relatively harsh milieu, enduring both radial forces and torques, upon use of the actuator. Advantageously, the lubricating member allows for lubrication of the load-carrying member, in particular, of portions of the load-carrying member facing the piston.

In an embodiment, the lubricating member is a separate component of the linear actuator. By being a separate component of the actuator, the lubricating member may easily be removed as a solid part (excluding the small amount of lubricating material that may gradually migrate to the surface(s) being subjected to a load upon use of the actuator) and be recycled at the end of life of the actuator. A lubricating member being provided as a separate component differs from e.g. a surface treatment layer or a surface treatment composition provided on the outer surface of the piston or on the inner load-carrying surface of the housing. Alternatively, the lubricating member may be an integrated component of the actuator.

The lubricating member may have a shape suitable for its intended use. In an embodiment, the lubricating member has the shape of a bushing. A bushing may easily be arranged around the piston, and may also easily be separated therefrom. In such an arrangement, the lubricating member may surround the entire periphery of a cross-section of the piston.

Alternatively, the lubricating member being provided as a separate component may have the shape of at least three separate points or separate flanges. In such an arrangement, the lubricating member typically does not surround the entire periphery of a cross-section of the piston, but a portion of the periphery of a cross-section of the piston.

In an embodiment, the lubricating member is further arranged in between the male spline and the female spline, respectively, of a rotational locking, as seen in the radial direction. The lubricating member may have a shape suitable to fit the space between the male spline in the load-carrying member and the piston in the radial direction.

The lubricating member may comprise an amount of lubricating material proportional to the needs of the electro-mechanical actuator during its entire service life. Thus, the amount of lubricating material in the lubricating member may be optimized both economically and environmentally based on the expected service life of the actuator.

By the term “load-carrying member” is herein meant a component of the linear electro-mechanical actuator serving to support and guide the piston over its, often relatively long, travel distance relative to the housing. The load-carrying member is generally arranged in the inner milieu of the actuator formed by the housing (i.e in the inner milieu of the housing). The load-carrying member may be arranged between the piston and the housing as seen in the radial direction. The load-carrying member generally has an outer load-carrying surface facing the inner load-carrying surface of the housing.

In an embodiment, the load-carrying member is arranged such that it surrounds the entire periphery of a cross-section of the piston which forms a portion of the outer surface of the piston. The load-carrying member may be arranged about the piston. In an embodiment, the load-carrying member has the shape of a sleeve or a bushing.

The load-carrying member may be a guiding member. The guiding member may have the shape of a bushing or a sleeve, thereby generally surrounding the entire periphery of a cross-section of the piston. However, the guiding member does not necessarily have to surround the entire periphery of a cross-section of the piston, but may for instance consist of three separate points or flanges. The guiding member may be a linear guiding member. For instance, the guiding member may be a perforated sheet.

The guiding member may be an integrated part of the actuator, e.g. an integrated part of the housing. Alternatively, the guiding member may be a separate component of the actuator.

In an embodiment, the load-carrying member further comprises a male spline extending over at least a portion of the load-carrying member in the axial direction and being engageable with a female spline arranged in the housing. The male spline serves as a rotational locking when engaged with said female spline.

By the term “rotational locking” is herein meant an assembly of components of the linear electro-mechanical actuator serving to avoid the piston, and optionally additional translating components of the actuator, from revolving as well as to handle the torques generated inside the actuator, such as counter-forces to the torque being applied to the translating components by the rotating components. The rotational locking may consist of a male spline formed in the load-carrying member and a female spline formed in the housing.

By the term “housing” is herein meant the component of the actuator defining the inner milieu and serving to protect the components arranged therein. The housing is generally stationary in relation to the moveable piston. The housing may sometimes be referred to as a protection member, e.g. a protection tube, of the linear electro-mechanical actuator. The housing may be cylindrical or tubular. In an embodiment, the housing has the shape of a cylinder, such as a circular cylinder. Typically, the housing has the shape of a hollow circular cylinder. The housing may be metallic. For instance, the housing may be made of steel, e.g. stainless steel.

The housing has an inner load-carrying surface, typically, facing at least a portion of the piston, preferably, at least a portion of the outer surface of the piston.

In an embodiment, the linear electro-mechanical actuator further comprises a separating member being arranged adjacent to an opening of the housing, the opening being adapted to receive the distal end of the piston, and in between the piston and the housing as seen in the radial direction. Optionally, the lubricating member may also allow for lubrication of the separating member via the lubrication of the outer surface of the piston.

By the term “separating member” is herein meant a component of the actuator being arranged at the interface between the inner milieu and the outer milieu or at least close to this interface. One function of the separating member is to separate the inner milieu from the outer milieu in, or close to, the opening of the housing adapted to receive the distal end of the piston.

The separating member is typically arranged in between the piston and the housing as seen in a radial direction. The separating member may surround either the entire periphery of a cross-section of the piston or a portion thereof. The separating member may be arranged about the piston. The separating member is typically adapted to receive the distal end of the piston.

The separating member may be a scraper. A scraper is typically adapted to clean an outer surface of the piston from dirt and dust soiling the surface of the piston while it retracts into the inner milieu from the outer milieu. Thus, the scraper serves to preserve a relatively clean inner milieu of the actuator. The scraper is typically made in molded plastics. The scraper may be arranged about the piston.

The separating member may be sealing member. A sealing member is typically adapted to seal the interface between the outer surface of the piston and the housing in the radial direction. Thus, the sealing member serves to seal the opening between the inner milieu and the outer milieu in order to prevent leakages. The sealing member is typically made in molded plastics. The sealing member may be arranged about the piston.

Both a scraper and a sealing member may be present in the linear electro-mechanical actuator. In an example embodiment, the actuator comprises a first separating member being a scraper and a second separating member being a sealing member. The scraper may be arranged relatively closer to the outer surface of the piston. The sealing member may be arranged to seal the opening present in the radial direction between the scraper and the housing.

By the term “transmission module” is herein meant the module of components of the actuator being adapted to transfer a rotational motion generated by a motor to a linear motion of the piston in the axial direction,

In an embodiment, the transmission module comprises a rotating portion and a non-rotating portion being operatively engageable to each other. The non-rotating portion is operatively connected to the proximal end of the piston. The transmission module is adapted to transfer a rotational motion of the rotating portion to a linear motion of the piston in the axial direction via the non-rotating portion.

The transmission module may comprise a screw having a threaded outer surface, and a nut having a threaded inner surface, wherein the screw and the nut are operatively engageable to each other. The threading of the screw and the threading of the nut typically has the same pitch. In this example, the nut is typically operatively connected to the proximal end of the piston.

The screw may be a sliding screw, a roller screw or a boll roller screw. The nut may be a torotionally locket nut, such as a sliding nut, or a nut comprising rolling elements, such as a ball nut or a roller nut. Generally, the nut is complementary to the screw.

In an embodiment, the rotating portion is a screw and the non-rotating portion is a nut.

In another embodiment, the rotating portion is a nut and the non-rotating portion is a screw.

One common type of linear actuators incorporates a screw shaft with a nut running thereon. The screw shaft extends over the full length of the actuator and sets the operating length of the actuator. Since the nut is held in a non-rotatable state, the nut will be displaced when the screw shaft is rotated by the motor. The nut may incorporate rolling elements, such as balls or rollers, between the screw shaft and the nut. This will allow for a high-efficiency linear actuator with high load transfer and long service life. The nut may also engage directly with the screw shaft, i.e. a sliding screw design. In this case, the nut is preferably made of a plastic material.

Generally, a linear electro-mechanical actuator further comprises, or is connected to, a motor, such as an electrical motor. The electrical motor may generate a rotational motion of the transmission module. The motor may comprise a motor element, which may be fixedly attached to the housing, and a rotor element, which may be fixedly attached to the transmission module.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing embodiments of the invention.

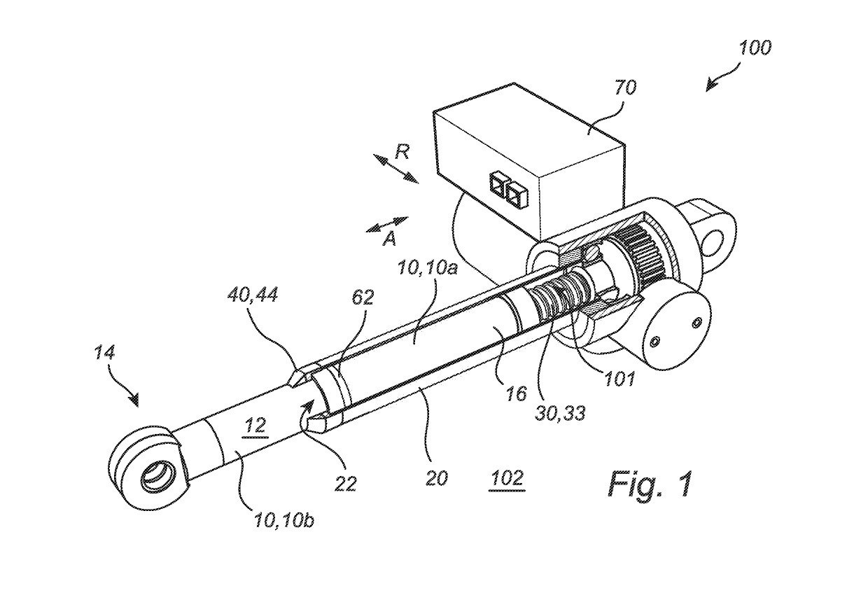

In FIG. 1, a linear electro-mechanical actuator according to an example embodiment of the present invention is schematically shown in a perspective view.

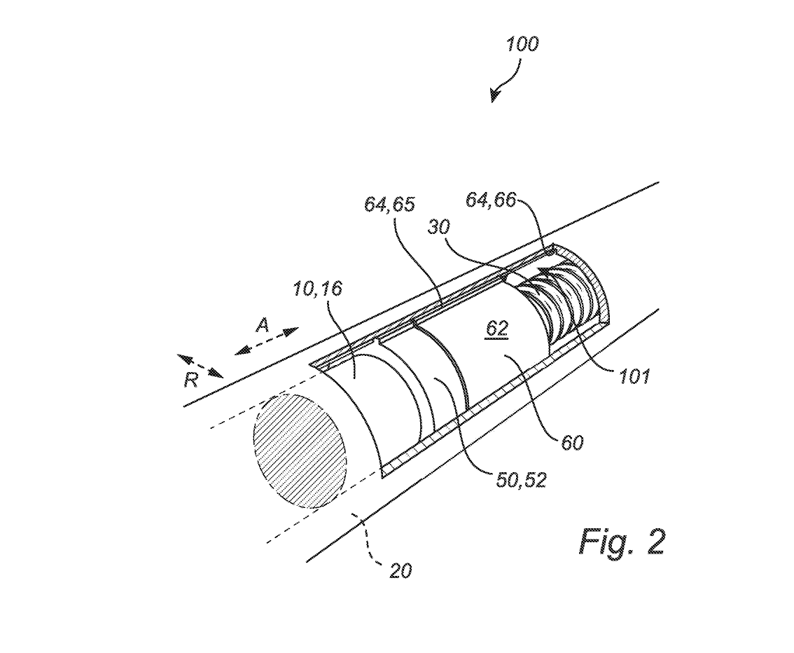

In FIG. 2, a portion of a linear electro-mechanical actuator according to an example embodiment of the present invention is schematically shown in a perspective view and in an assembled state.

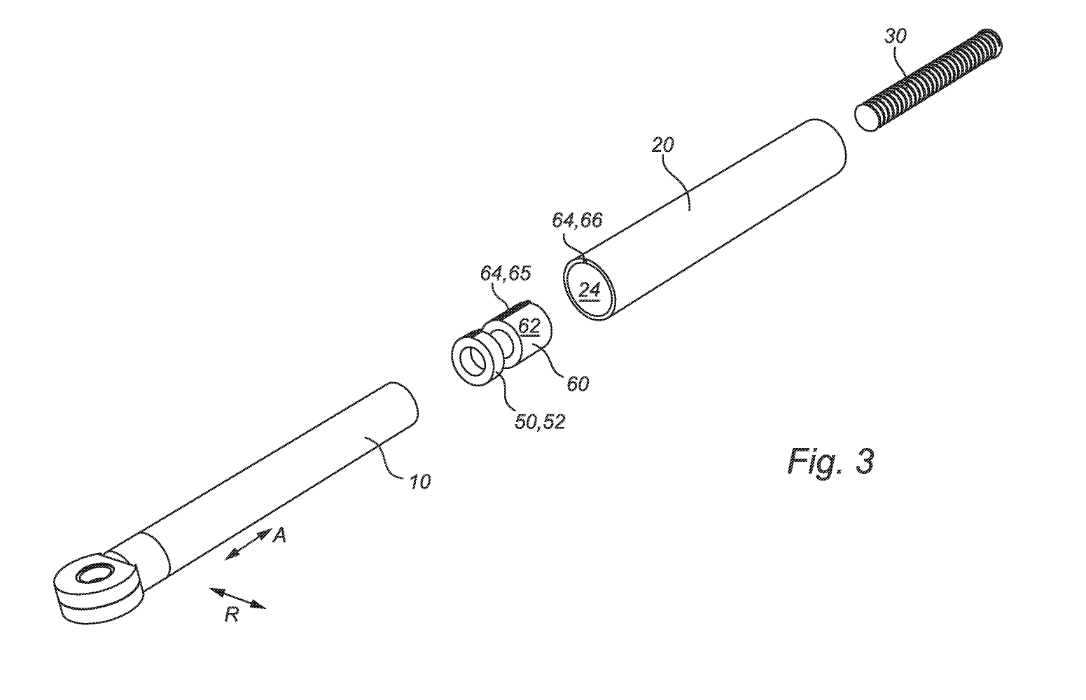

In FIG. 3, a portion of a linear electro-mechanical actuator according to an example embodiment of the present invention is schematically shown in an exploded view.

### DETAILED DESCRIPTION OF THE INVENTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

The present invention relates to a linear electro-mechanical actuator 100 for transferring a rotational motion to a linear motion, which is schematically shown in FIG. 1. It should be readily appreciated that the linear electro-mechanical actuator may sometimes be denoted as the linear actuator or the actuator for the sake of simplicity. The actuator comprises a piston 10, a housing 20, a transmission module 30, and a load-carrying member 60 here in the form of a guiding member 62. In FIG. 1, the example embodiment of the actuator here further comprises a separating member 40 and a motor 70. Throughout this description, the piston extends in the axial direction A and in the radial direction R. The linear electro-mechanical actuator further comprises a lubricating member (not shown in FIG. 1) described in more detail below.

The piston 10 has a distal end 14 and a proximal end 16. The piston 10 extends in an axial direction A and has an outer surface 12. The piston 10 is moveable relative to the housing in the axial direction A. The housing 20 defines an inner milieu 101. The housing 20 has here a shape of a circular cylinder and comprises an opening 22 adapted to receive the distal end 14 of the piston 10. The housing 20 comprises an inner load-carrying surface (not shown in FIG. 1, but as 24 in FIG. 3), facing at least a portion of the piston 10, e.g. the outer surface of the piston 12, in an assembled state of the actuator.

As shown in FIG. 1, the piston 10 is at least partly arranged in the housing 20. The part of the piston 10a being arranged inside the housing is arranged in the inner milieu 101. The part of the piston 10b extending outside the housing is arranged in the outer milieu 102. In a fully retracted state, the piston is mainly, typically entirely, arranged in the inner milieu. In a fully extended state, the piston is mainly, typically entirely, arranged in the outer milieu. In FIG. 1, the piston is in a partly extended state.

The transmission module 30 is operatively connected to the proximal end of the piston 10 and adapted to transfer a rotational motion generated by the motor 70 to a linear motion of the piston 10 in the axial direction A.

Although not strictly required, the transmission module 30 comprises a rotatable screw shaft 33 with a non-rotatable nut (not shown) running thereon. The screw shaft extends over the full length of the actuator and sets the operating length of the actuator. The nut is held in a non-rotatable state, and is displaced when the screw shaft is rotated by the motor 70. The transmission module 30 is at least partly arranged inside the piston 10.

As shown in FIG. 1, the linear electro-mechanical actuator may optionally comprise a separating member 40. The separating member 40 is arranged adjacent to an opening 22 of the housing 20. The opening 22 is adapted to receive the distal end of the piston. The separating member 40 is further arranged in between the piston 10 and the housing 20 as seen in the radial direction R.

The separating member 40, herein shown as a scraper 44, separates the inner milieu 101 from the outer milieu 102 at the opening 22 of the housing adapted to receive the distal end 14 of the piston. The scraper 44 further serves to clean the outer surface 12 of the piston when retracting from the outer milieu into the inner milieu.

The actuator further includes the load-carrying member 60, which is arranged in between the piston 10 and the housing 20 as seen in a radial direction R at the proximal end of the piston. The load-carrying member typically has an inner load-carrying surface and an outer load-carrying surface. The inner load-carrying surface may face at least a portion of the outer surface of the piston and the outer load-carrying surface may face at least a portion of the inner load-carrying surface of the housing.

The load-carrying member 60, here represented by a guiding member 62, is arranged in the inner milieu. The guiding member 62 may be arranged either closer to the proximal end of the piston or closer to the distal end of the piston. In FIG. 1, the guiding member 62 is arranged rather in the centre part of the piston. The guiding member serves to keep the piston 10 on track during its linear movements in the axial direction A. In particular, the guiding member serves to guide the piston such that it travels efficiently as it moves in the axial direction relative the housing.

In FIGS. 2 and 3, a portion of the linear electro-mechanical actuator 100 in FIG. 1 is shown in more detail, namely, the lubricating member 50 and its surroundings. FIG. 2 shows the lubricating member 50 and its surroundings in an assembled state, while FIG. 3 is an exploded view of the lubricating member 50 and its surroundings. All features of the actuator 100 are not necessarily explicitly shown in both FIGS. 2-3.

The piston 10 having a distal end (not shown) and a proximal end 16 extends in the axial direction A. The proximal end 16 is arranged inside the housing 20, and, thus, in the inner milieu 101.

The proximal end 16 of the piston is operatively connected to the transmission module 30, typically via a nut 37. The nut 37 has a threaded inner surface 38 and is operatively engageable with a screw 33 of the transmission module. The screw has a treaded outer surface 34. A rotational motion of the screw may be generated by a motor 70.

As mentioned above, the lubricating member 50 comprises a porous polymeric matrix and a lubricating material. In addition, as illustrated in FIG. 2, the lubricating member 50 is present in the inner milieu 101 and arranged in between the housing 20 and the piston 10 as seen in the radial direction R at the proximal end of the piston. The lubricating member 50 is, directly or indirectly, attached to the piston 10, such as to the outer surface 12 of the piston. The lubricating member 50 is not freely moveable in the axial direction A relative to the piston 10. On the other hand, both the lubricating member 50 and the piston 10 are freely moveable in the axial direction A relative to the housing 20.

It should be readily appreciated that in all of the embodiments of the present invention, the lubricating member may not necessarily be a bushing. Accordingly, the lubricating member may be provided in several different forms as long as the lubricating member can include a porous polymeric matrix and a lubricating material while fulfilling the required function of the lubricating member.

At the proximal end 16 of the piston, the load-carrying member 60 is arranged. The load-carrying member 60 is entirely arranged in the inner milieu 101. The lubricating member 50 is arranged adjacent to the load-carrying member 60, thus, towards the proximal end 16 of the piston 10, at least when the piston is in its fully retracted state. The lubricating member 50 is entirely arranged in the inner milieu 101.

In FIGS. 2 and 3, it can be seen that the load-carrying member 60 is arranged in between the transmission module 30 and the lubricating member 50 as seen in the axial direction A. As seen in FIG. 2, both the lubricating member 50 and the load-carrying member 60 are arranged in between the piston 10 and the housing 20 as seen in the radial direction R.

In FIG. 2, the load-carrying member 60 here comprises both a guiding member 62 and a male spline 65 of a rotational locking 64.

The guiding member 62 here has the general shape of a sleeve. The guiding member 62 surrounds almost the entire periphery of a cross-section of the piston. The guiding member 62 is arranged about the piston 10.

A rotational locking 64 here consists of a male spline 65 in the load-carrying member 60 and a female spline 66 in the housing 20. The male spline 65 of the rotational locking 64 is engageable with the female spline 66. While, the male spline 65 is formed by a portion of the load-carrying member 60, the female spline is rather forming a part of the housing 20.

The lubricating member 50 is arranged adjacent to the load-carrying member 60. That is, the lubricating member 50 is arranged at a minor distance from the load-carrying member 60 as seen in the axial direction A. The lubricating member 50 is arranged about the piston and has the general shape of a bushing 52. The bushing 52 surrounds almost the entire periphery of a cross-section of the piston. The lubricating member 50 here in the shape of a bushing 52 includes a portion suitable to fit inside the male spline 65 of the rotational locking 64.

Typically, load-carrying member 60, here the guiding member 62, is load-carrying, while the lubricating member 50 is not. In order to ensure a smooth operation of the linear actuator, the housing 20 should be freely moveable in the axial direction A relative to at least the lubricating member 50.

The arrangement of the linear electro-mechanical actuator, shown in general in FIG. 1 and in more detail in FIGS. 2 and 3, allows for lubrication of at least a portion of the inner load-carrying surface 24 of the housing 20 by the lubricating material of the lubricating member 50 upon movement of the piston.

In all of the embodiments of the present invention, there is provided a linear electro-mechanical actuator which is capable of improving the application of the lubrication in terms of precision and functionality, while providing a precise amount of a lubricating material. In this context, the linear electro-mechanical actuator according to the present invention may not even require relubrication. More specifically, by the arrangement of the linear electro-mechanical actuator as described above, it becomes possible to assemble the actuator easily in a dry state of the lubricating member, i.e. with no smeary grease, or other form of liquid or semi-liquid lubricating material, present except in the porous polymeric matrix of the lubricating member. In addition, the linear electro-mechanical actuator may easily be used due to a relatively controlled consumption of lubricating material causing substantially no leakage of lubricating material as well as due to its tolerance to e.g. washing as well as the linear electro-mechanical actuator may allow for environmentally friendly handling of the lubricating member including the unconsumed lubricating material at end of service life, in particular when provided as a separate member.

### REFERENCE NUMBERS

100 linear electro-mechanical actuator
101 inner milieu
102 outer milieu
A axial direction
R radial direction
10 piston
10a part of piston in the inner milieu
10b part of piston in the outer milieu
12 outer surface of the piston
14 distal end of the piston
16 proximal end of the piston
18 cross-section of the piston
19 periphery of the cross-section of the piston
20 housing
22 opening being adapted to receive the distal end of the piston
24 inner load-carrying surface of the housing
30 transmission module
32 rotating portion
33 screw
34 threaded outer surface
36 non-rotating portion
37 nut
38 threaded inner surface
40 separating member
42 sealing member
44 scraper
50 lubricating member
52 bushing
60 load-carrying member
62 guiding member
64 rotational locking
65 male spline
66 female spline
70 motor

1. A linear electro-mechanical actuator for transferring a rotational motion to a linear motion comprising:
a piston having a distal end and a proximal end, the piston extending in an axial direction and having an outer surface, the piston being at least partly arranged inside a housing, the housing defining an inner milieu and having an inner load-carrying surface, wherein the piston is moveable relative to the housing in the axial direction,
a transmission module operatively connected to the proximal end of the piston and adapted to transfer a rotational motion generated by a motor to a linear motion of the piston in the axial direction,
a load-carrying member being arranged in between the piston and the housing in a radial direction at the proximal end of the piston,
a lubricating member having a porous polymeric matrix and a lubricating material and being present in the inner milieu and arranged in between the housing and the piston in the radial direction at the proximal end of the piston,
wherein the lubricating member is arranged adjacent to the load-carrying member, thereby allowing for lubrication of at least a portion of the inner load-carrying surface of the housing by the lubricating material upon movement of the piston.

2. A The linear electro-mechanical actuator according to claim 1, further comprising allowing for lubrication of substantially the entire inner load-carrying surface of the housing by the lubricating material.

3. The linear electro-mechanical actuator according to claim 1, wherein the lubricating member is a separate component of the linear actuator.

4. The linear electro-mechanical actuator according to claim 1, wherein the lubricating member has the shape of a bushing.

5. The linear electro-mechanical actuator according to claim 1, wherein the load-carrying member is arranged such that it surrounds the entire periphery of a cross-section of the piston that forms a portion of the outer surface of the piston.

6. The linear electro-mechanical actuator according to claim 1, wherein the load-carrying member has the shape of one of a sleeve and a bushing.

7. The linear electro-mechanical actuator according to claim 1, wherein the load-carrying member further comprises a male spline extending over at least a portion of the load-carrying member in the axial direction and being engageable with a female spline arranged in the housing, wherein the male spline serves as a rotational locking when engaged with the female spline.

8. The linear electro-mechanical actuator according to claim 8, wherein the lubricating member is further arranged in between the male spline and the female spline in the radial direction (R).

9. The linear electro-mechanical actuator according to claim 1, wherein the housing has the shape of a cylinder.

10. The linear electro-mechanical actuator according to claim 1, further comprising a separating member being arranged adjacent to an opening of the housing, the opening being adapted to receive the distal end of the piston, and in between the piston and the housing in the radial direction.

11. The linear electro-mechanical actuator according to claim 1, wherein the transmission module further comprises a rotating portion and a non-rotating portion being operatively engageable to each other, and wherein the non-rotating portion is operatively connected to the proximal end of the piston, the transmission module being adapted to transfer a rotational motion of the rotating portion to a linear motion of the piston in the axial direction (A) via the non-rotating portion.

12. The linear electro-mechanical actuator according to claim 11, wherein the rotating portion is a screw and the non-rotating portion is a nut.

13. The linear electro-mechanical actuator according to claim 11, wherein the rotating portion is a nut and the non-rotating portion is a screw.
